(19) United States
(12) Patent Application Publication
(10) Pub. No.: US 2012/0019728 A1
(43) Pub. Date: Jan. 26, 2012

(54) Dynamic Illumination Compensation For Background Subtraction

(76) Inventor: Darnell Janssen Moore, Allen, TX (US)

(21) Appl. No.: 13/190,404

(22) Filed: Jul. 25, 2011

Related U.S. Application Data
(60) Provisional application No. 61/367,611, filed on Jul. 26, 2010.

(51) Int. Cl. H04N 5/52

(52) U.S. Cl. 348/678; 348/E05.115

(57) ABSTRACT

A method of processing a video sequence in a computer vision system is provided that includes receiving a frame of the video sequence, computing a gain compensation factor for a tile in the frame as an average of differences between background pixels in the tile and corresponding pixels in a background model, computing a first difference between a pixel in the tile and a sum of a corresponding pixel in the background model and the gain compensation factor, and setting a location in a foreground mask corresponding to the pixel based on the first difference.

### CROSS-REFERENCE TO RELATED APPLICATIONS

This application claims benefit of U.S. Provisional Patent Application Ser. No. 61/367,611, filed Jul. 26, 2010, which is incorporated by reference herein in its entirety.

### BACKGROUND OF THE INVENTION

1. Field of the Invention

Embodiments of the present invention generally relate to a method and apparatus for dynamic illumination compensation for background subtraction.

2. Description of the Related Art

Detecting changes in video taken by a video capture device with a stationary field-of-view, e.g., a fixed mounted video camera with no pan, tilt, or zoom, has many applications. For example, in the computer vision and image understanding domain, background subtraction is a change detection method that is used to identify pixel locations in an observed image where pixel values differ from co-located values in a reference or “background” image. Identifying groups of different pixels can help segment objects that move or change their appearance relative to an otherwise stationary background.

### SUMMARY

Embodiments of the present invention relate to a method, apparatus, and computer readable medium for background subtraction with dynamic illumination compensation. Embodiments of the background subtraction provide for receiving a frame of a video sequence, computing a gain compensation factor for a tile in the frame as an average of differences between background pixels in the tile and corresponding pixels in a background model, computing a first difference between a pixel in the tile and a sum of a corresponding pixel in the background model and the gain compensation factor, and setting a location in a foreground mask corresponding to the pixel based on the first difference.

### BRIEF DESCRIPTION OF THE DRAWINGS

Particular embodiments in accordance with the invention will now be described, by way of example only, and with reference to the accompanying drawings:

FIGS. 1A-2C show examples of background subtraction;

FIGS. 3A-3C show an example illustrating inter-frame difference and motion history;

FIG. 4 shows a block diagram of a computer vision system;

FIG. 5 shows a flow diagram of a method for background subtraction with compensation for dynamic illumination;

FIG. 6 shows an example of applying background subtraction with compensation for dynamic illumination; and

FIG. 7 shows an illustrative digital system.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

Background subtraction works by first establishing a model or representation of the stationary field-of-view of a camera. Many approaches can be used to define the background model. For example, a naïve technique defines a single frame in a sequence of video frames S as the background model Bₜ such that

Bₜ(x,y)=Iₜ(x,y),

where S={I₀, I₁, I₂, . . . , Iₜ, Iₜ₊₁, . . . } and Iₜ and Bₜ are both N×M arrays of pixel values such that 1≦x≦M and 1≦y≦N. In some instances, the first frame in the sequence is used as the background model, e.g., Bₜ(x,y)=I₀(x,y).

A more sophisticated technique defines a Gaussian distribution to characterize the luma value of each pixel in the model over subsequent frames. For example, the background model Bₜ can be defined as a pixel-wise, exponentially-weighted running mean of frames, i.e.,

Bₜ(x,y)=(1−α(t))·Iₜ(x,y)+α(t)·Bₜ₋₁(x,y), (1)

where α(t) is a function that describes the adaptation rate. In practice, the adaptation rate α(t) is a constant between zero and one. When Bₜ(x,y) is defined by Eq. 1, the pixel-wise, exponentially-weighted running variance Vₜ(x,y) is also calculated such that

Vₜ(x,y)=|(1−α(t))·Vₜ₋₁(x,y)+α(t)·Δₜ(x,y)²|. (2)

In any case, once the background model has been determined, detecting changes between the current frame Iₜ and the background Bₜ is generally a simple pixel-wise arithmetic subtraction, i.e.,

Δₜ(x,y)=Iₜ(x,y)−Bₜ(x,y). (3)

A pixel-wise threshold Tₜ(x,y) is often applied to Δₜ(x,y) to help determine if the difference in pixel values at a given location (x,y) is large enough to attribute to a meaningful “change” versus a negligible artifact of sensor noise. If the the pixel-wise mean and variance is established for the background model Bₜ, the threshold Tₜ(x,y) is commonly set as a standard deviation of the variance, e.g., Tₜ(x,y)=λ √ Vₜ(x,y) where λ is the standard deviation factor.

A two-dimensional binary map Hₜ for the current frame Iₜ is defined as

Hₜ(x,y)={1 if |Δₜ(x,y)|>Tₜ(x,y); otherwise 0} ∀ 1≦x≦M and 1≦y≦N (4)

The operation defined by Eq. 4 is generally known as “background subtraction” and can be used to identify locations in the image where pixel values have changed meaningfully from recent values. These locations are expected to coincide with the appearance of changes, perhaps caused by foreground objects. Pixel locations where no significant change is measured are assumed to belong to the background. That is, the result of the background subtraction, i.e., a foreground mask Hₜ, is commonly used to classify pixels as foreground pixels or background pixels. For example, Hₜ(x,y)=1 for foreground pixels versus Hₜ (x,y)=0 for those associated with the background. In practice, this map is processed by grouping or clustering algorithms, e.g., connected components labeling, to construct higher-level representations, which in turn, feed object classifiers, trackers, dynamic models, etc.

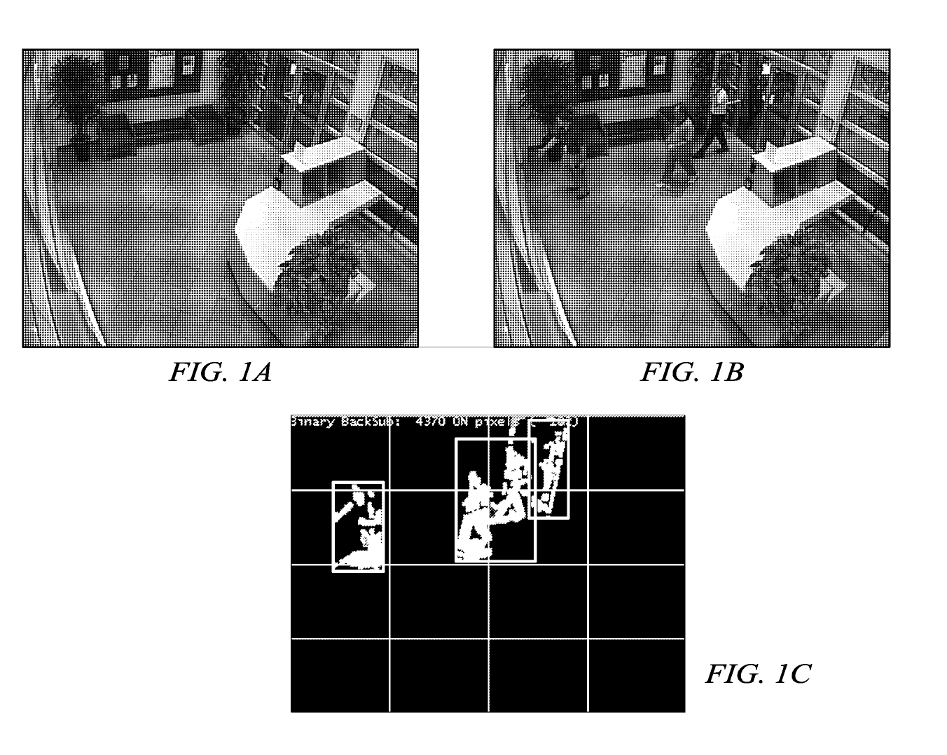

FIGS. 1A-1C show an example of background subtraction. FIG. 1C is the result of subtracting the gray-level background image of a lobby depicted in FIG. 1A from the gray-level current image of the lobby in FIG. 1B (with additional morphological processing performed on the subtraction result to remove sparse pixels). In this example, variation in background pixel values due to sensor noise is contained within the threshold, which enables fairly clean segmentation of the pixels associated with the moving objects, i.e., people, in this scene. However, when illumination conditions in the scene change quickly for brief periods of time, background pixel values in the captured image can experience much more significant variation. For example, as shown in FIGS. 2A-2C, an open door floods the lobby with lots of natural light. Additionally, the gain control of the camera is applied. As can be seen by comparing FIG. 1C to FIG. 2C, using the same threshold as used for the background subtraction of FIGS. 1A-1C, the binary background subtraction map Hₜ can no longer resolve the foreground pixels associated with the moving objects because pixel variation in otherwise stationary areas is so large.

There are many factors, or combinations of factors, that can produce these transient conditions, including camera automatic gain control and brightly colored objects entering the field of view. In response to dynamic illumination conditions in the overall image, many cameras equipped with gain control apply an additive gain distribution Gₜ(x,y) to the pixels in the current frame Iₜ(x,y) to produce an adjusted frame Iₜ(x,y) that may be more subjectively appealing for humans. However, this gain is generally unknown to the background subtraction algorithm, which can lead to errors in segmentation. This behavior represents a common issue in real time vision systems.

Embodiments of the invention provide for background subtraction that compensates for dynamic changes in illumination in a scene. Since each pixel in an image is potentially affected differently during brief episodes of illumination change, the pixels in the current image may be represented as Iₜ(x,y) such that

Îₜ(x,y)=Iₜ(x,y)+Gₜ(x,y), (5)

where Gₜ(x,y) is an additive transient term that is generally negligible outside the illumination episode interval. An additive gain compensation term Cₜ(x,y) is introduced to the background model that attempts to offset the contribution from the unknown gain term Gₜ(x,y) that is added to the current frame Iₜ(x,y), i.e.,

Îₜ(x,y)−(Bₜ(x,y)+Cₜ(x,y))≈Iₜ(x,y)−Bₜ(x,y). (6)

More specifically, Cₜ(x,y) is estimated such that Cₜ(x,y)≈−Gₜ(x,y).

To estimate the gain compensation term Cₜ(x,y), the two dimensional (2D) (x,y) locations in a frame where the likelihood of segmentation errors are low are initially established. This helps to identify pixel locations that have both a low likelihood of containing foreground objects and a high likelihood of belonging to the “background”, i.e., of being stable background pixels.

A 2D binary motion history mask Fₜ is used to assess these likelihoods. More specifically, for each image or frame, the inter-frame difference, which subtracts one time-adjacent frame from another, i.e., Iₜ(x,y)−Iₜ₋₁(x,y), provides a measure of change between frames that is independent of the background model. The binary motion history mask Fₜ is defined by

Fₜ(x,y)={1 if (Mₜ(x,y)>0); otherwise 0}, ∀ x,y (7)

where Mₜ is a motion history image representative of pixel change over q frames, i.e.,

Mₜ(x,y)={q if (Dₜ(x,y)=1); otherwise max[0, Mₜ(x,y)−1]} (8)

where q is the motion history decay constant and Dₜ is the binary inter-frame pixel-wise difference at time t, i.e.,

Dₜ(x,y)={1 if |Iₜ(x,y)−Iₜ₋₁(x,y)|>τₜ(x,y); otherwise 0} ∀ 1≦x≦M and 1≦y≦N. (9)

Note that Tₜ(x,y) and τₜ(x,y) are not necessarily the same. For simplicity, τₜ(x,y) is assumed to an empirically determined constant.

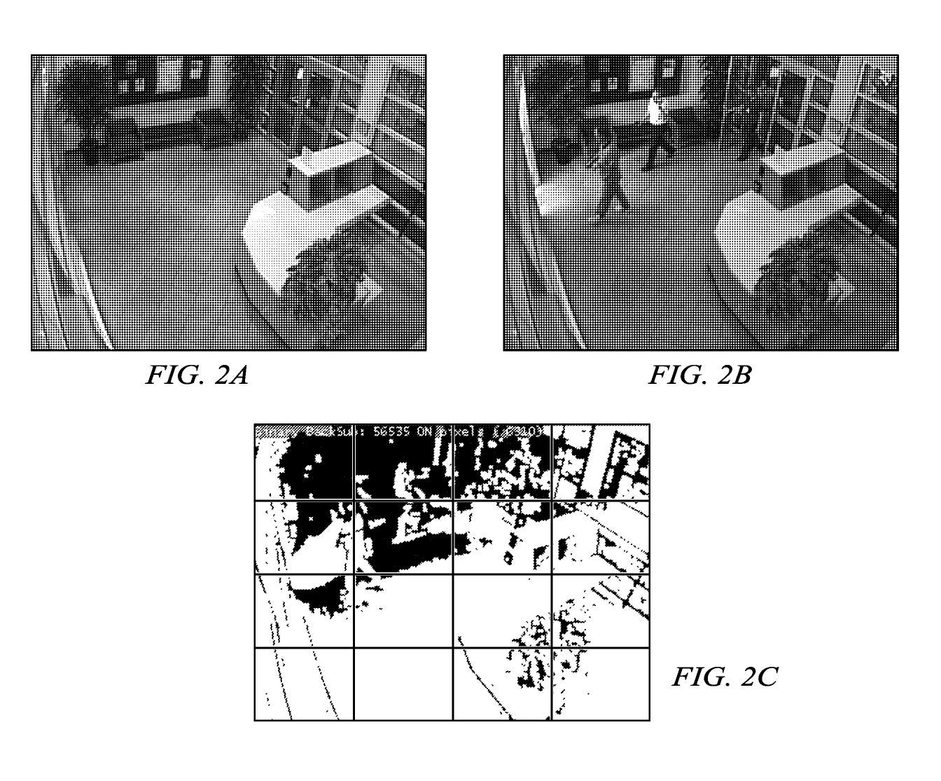

To estimate the gain distribution Gₜ(x,y) in frame t, background pixel values in the current frame Iₜ(x,y) are monitored to detect changes beyond a threshold β. Although Dₜ(x,y)=0 indicates no pixel change at (x,y) over the interval between time t and t−1, the inter-frame difference result Dₜ over a single interval may not provide adequate segmentation for moving objects. For example, the inter-frame difference tends to indicate change along the leading and trail edges of moving objects most prominently, especially if the objects are homogeneous in appearance. The binary motion history mask Fₜ is essentially an aggregate of Dₜ over the past q intervals, providing better evidence of pixel change over q intervals. A background pixel location (x,y) is determined whenever Fₜ(x,y)=0. As is describe in more detail herein, pixel locations involved in the calculation of the gain compensation term Cₜ(x,y) are also established by the binary motion history mask Fₜ. FIGS. 3A-3C show, respectively, a simple example of a moving object over four frames, the binary inter-frame difference Dₜ for each frame, and the binary motion history mask Fₜ for each frame.

Applying a single gain compensation term for the entire frame, i.e., Cₜ(x,y)=constant ∀ x, y, may poorly characterize the additive gain distribution Gₜ(x,y), especially if the gain compensation term is determined by a non-linear 2D function. To minimize the error between Cₜ(x,y) and Gₜ(x,y), Cₜ(x,y) is estimated as a constant c in a 2D piece-wise fashion. For example, estimating and applying Cₜ(x,y) as a constant to a subset or tile of the image Φ, e.g., 1≦x≦M/4 and 1≦y≦N/4, reduces segmentation errors more than allowing x and y to span the entire N×M image. The constant c for a tile in an image is estimated by averaging the difference between the background model Bₜ(x,y) and the image Iₜ(x,y) at 2D (x,y) pixel locations determined by Fₜ(x,y), i.e.,

Cₜ(x,y)≈c=1/n·Σ(1−Fₜ(x,y))·[Îₜ(x,y)−Bₜ(x,y)] ∀ x, y ∈ Φ, (10)

where n is the number of pixels that likely belong to the background, or

n=Σ(1−Fₜ(x,y)). (11)

Note that the constant c is not necessarily the same for all subsets or tiles. The constant c may also be referred to as the mean illumination change or the gain compensation factor. By re-calculating background subtraction compensated by c, i.e.,

Δ_{t,2}(x,y)=Îₜ(x,y)−(Bₜ(x,y)+c) (12)

and comparing this difference to the original, uncompensated background subtraction, i.e.,

Δ_{t,1}(x,y)=Îₜ(x,y)−Bₜ(x,y), (13)

segmentation errors that can cause subsequent processing stages to fail can generally be reduced by selecting the result producing the smallest change. That is, the final binary background mask is defined as

Ĥₜ(x,y)={1 if (min[Δ_{t,1}(x,y), Δ_{t,2}(x,y)]>Tₜ(x,y)); otherwise 0}∀ x, y ∈ Φ. (14)

Embodiments of the gain compensated background subtraction techniques have been shown to result in the same or fewer errors in segmentation as compared to uncompensated background segmentation. Further, the compensation approach is applied to selective areas of an image, e.g., block-based tiles, making the illumination compensated background subtraction amenable to SIMD implementations and software pipelining. In addition, the illumination compensated background can be applied iteratively, which tends to improve the performance.

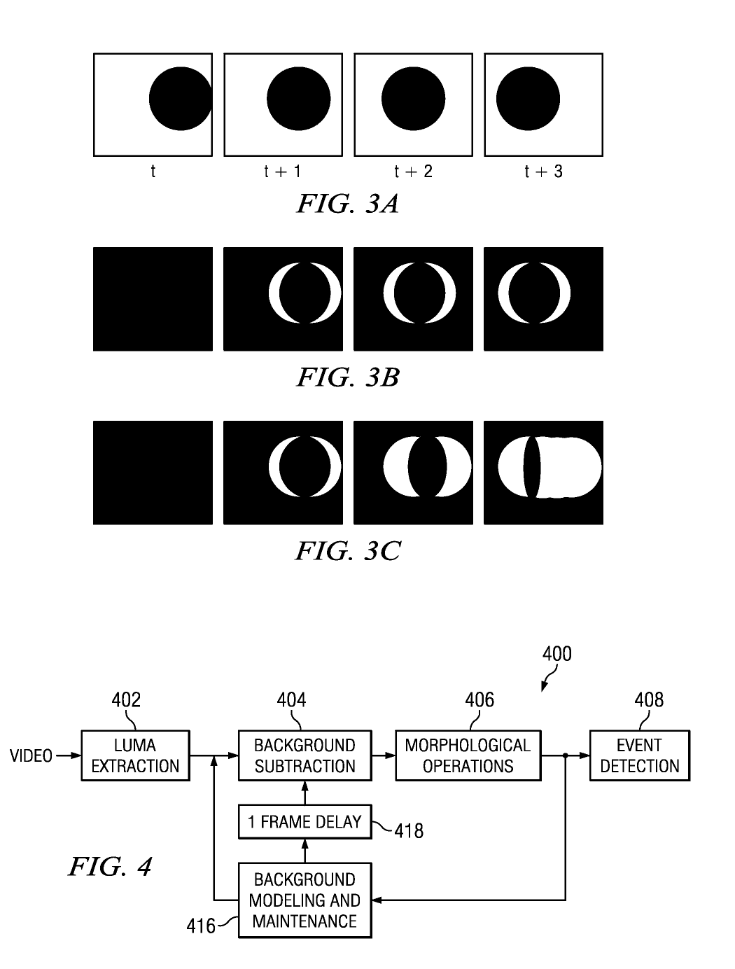

FIG. 4 shows a simplified block diagram of a computer vision system 400 configured to use gain compensated background subtraction as described herein. The computer vision system 400 receives frames of a video sequence and analyzes the received frames using various computer vision techniques to detect events relevant to the particular application of the computer vision system 400, e.g., video surveillance. For example, the computer vision system 400 may be configured to analyze the frame contents to identify and classify objects in the video sequence, derive information regarding the actions and interactions of the objects, e.g., position, classification, size, direction, orientation, velocity, acceleration, and other characteristics, and provide this information for display and/or further processing. The components of the computer vision system 400 may be implemented in any suitable combination of software, firmware, and hardware, such as, for example, one or more digital signal processors (DSPs), microprocessors, discrete logic, application specific integrated circuits (ASICs), etc.

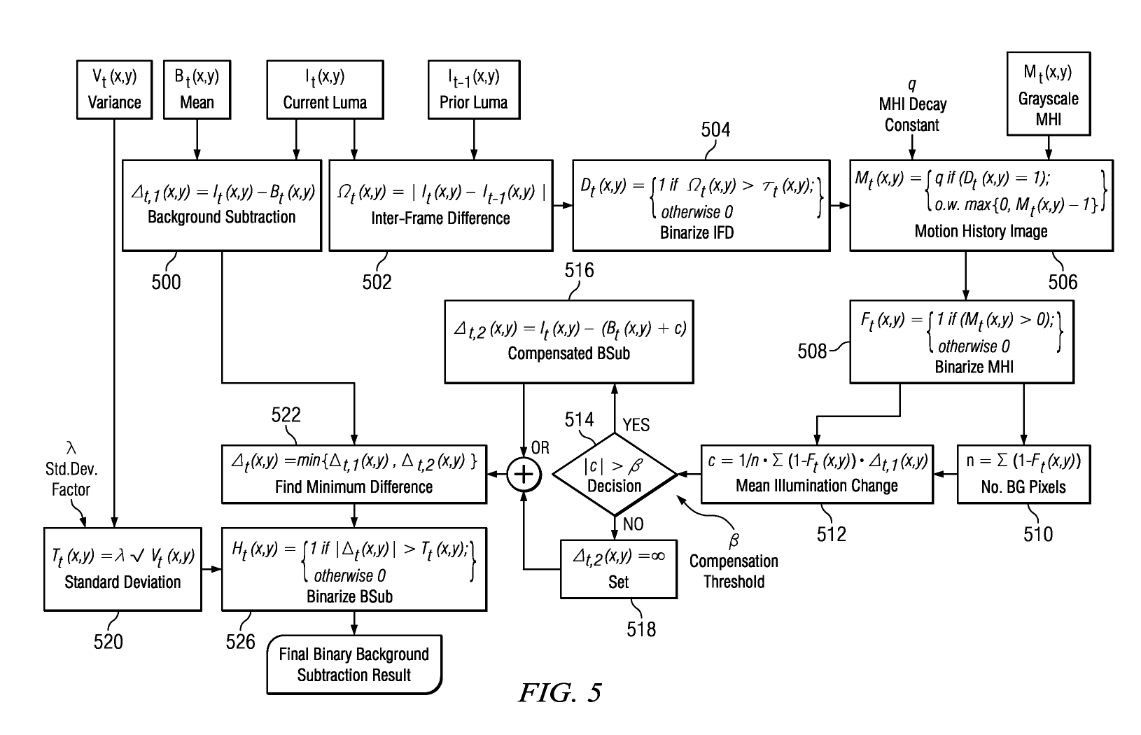

The luma extraction component 402 receives frames of image data and generates corresponding luma images for use by the other components. The background subtraction component 404 performs gain compensated background subtraction as described herein, e.g., as per Eqs. 7-14 above or the method of FIG. 5, to generate a foreground mask based on each luma image. The background model used by the background subtraction component 404 is initially determined and is maintained by the background modeling and maintenance component 416. The background modeling and maintenance component 416 adapts the background model over time as needed based on the content of the foreground masks and motion history binary images generated by the background subtraction component 404. The one frame delay 418 indicates that the updated background model is available for processing the subsequent frame after background subtraction and morphological cleaning have been completed for the current frame.

The morphological operations component 406 performs morphological operations such as dilation and erosion to refine the foreground mask, e.g., to remove isolated pixels and small regions. The event detection component 408 analyzes the foreground masks to identify and track objects as they enter and leave the scene in the video sequence to detect events meeting specified criteria, e.g., a person entering and leaving the scene, and to send alerts when such events occur. As part of sending an alert, the event detection component 414 may provide object metadata such as width, height, velocity, color, etc. The event detection component 408 may classify objects as legitimate based on criteria such as size, speed, appearance, etc. The analysis performed by the event detection component 408 may include, but is not limited to, region of interest masking to ignore pixels in the foreground masks that are not in a specified region of interest. The analysis may also include connected components labeling and other pixel grouping methods to represent objects in the scene. It is common practice to further examine the features of these high-level objects for the purpose of extracting patterns or signatures that are consistent with the detection of behaviors or events.

FIG. 5 shows a flow diagram of a method for dynamic illumination compensation in background subtraction, i.e., gain compensated background subtraction. This method assumes that the background model Bₜ is a mean image, i.e., a pixel-wise, exponentially-weighted running mean of frames as per Eq. 1. The method also assumes a variance image Vₜ, i.e., a pixel-wise, exponentially-weighted running variance of frames as per Eq. 2. This method is performed on each tile of a luma image Iₜ(x,y) extracted from a video frame to generate a corresponding tile in a foreground mask. The tile dimensions may be predetermined based on simulation results and/or may be user specified. In one embodiment, the tile size is 32 x 10. Note that each block in the flow diagram includes an equation illustrating the operation performed by that block.

As shown in FIG. 5, a background subtraction is performed to compute pixel differences Δ_{t,1}(x,y) between the tile Iₜ(x,y) and a corresponding tile Bₜ(x,y) in the background model 500. The inter-frame difference Ωₜ(x,y) between the tile Iₜ(x,y) and a corresponding tile the tile Iₜ₋₁(x,y) of the previous frame is also computed 502. The inter-frame difference Ωₜ(x,y) is then binarized based on a threshold τₜ(x,y) to generate an inter-frame motion mask Dₜ(x,y). To isolate the changed pixels between frames, it is important to set the threshold τₜ(x,y) just above the general noise level in the frame. Setting the threshold at or below the noise level makes it impossible to distinguish change caused by a moving object from noise introduced by the sensor or other sources. For example, the luma value measured at a single pixel value can easily fluctuate by +/−7 because of sensor noise, and significantly more under low-light conditions. In practice, good results have been achieved by setting this threshold τₜ(x,y) to a constant value while being applied to an entire frame; however, changing τₜ(x,y) dynamically between frames using heuristic methods that can assess the local noise level introduced by the sensor can also be deployed. That is, a location in the inter-frame motion mask Dₜ(x,y) corresponding to a pixel in the tile Iₜ(x,y) is set to indicate motion in the pixel if the absolute difference between that pixel and the corresponding pixel in the previous tile Iₜ₋₁(x,y) exceeds the threshold τₜ(x,y); otherwise, the location is set to indicate no motion in the pixel.

A motion history image Mₜ(x,y) representative of pixel value changes over some number of frames is then updated based on the inter-frame motion mask Dₜ(x,y) 506. The motion history image Mₜ(x,y) is representative of the change in pixel values over some number of frames q. The value of q, which may be referred to as the motion history decay constant, may be predetermined based on simulation and/or may be user-specified to correlate with the anticipated speed of typical objects in the scene.

The motion history image Mₜ(x,y) is then binarized to generate a binary motion history mask Fₜ(x,y) 508. That is, an (x,y) location in the binary motion history mask Fₜ(x,y) corresponding to a pixel in the current frame Iₜ(x,y) is set to one to indicate that motion has been measured at some point over the past q frames; otherwise, the location is set to zero, indicating no motion has been measured in the pixel location. Locations with no motion, i.e., Fₜ(x,y)=0, are herein referred to as background pixels. The number of background pixels n in the tile Iₜ(x,y) is determined from the binary motion history mask Fₜ(x,y) 510.

The mean illumination change c is then computed for the tile Iₜ(x,y) 512. The mean illumination change c is computed as the average pixel difference Δ_{t,1}(x,y) between pixels in the tile Iₜ(x,y) that are identified as background pixels in the binary motion history mask Fₜ(x,y) and the corresponding pixels in the background model Bₜ(x,y).

A determination is then made as to whether or not gain compensation should be applied to the tile Iₜ(x,y) 514. This determination is made by comparing the mean illumination change c to a compensation threshold R. The compensation threshold β may be predetermined based on simulation results and/or may be user-specified. If the mean illumination change c is not less than the compensation threshold β 514, background subtraction with gain compensation is performed on the tile Iₜ(x,y) 516 to compute gain compensated pixel differences Δ_{t,2}(x,y). That is, a gain compensation factor, which is the mean illumination change c, is added to each pixel in the background model Bₜ(x,y) corresponding to the tile Iₜ(x,y), and the gain compensated background model pixel values are subtracted from the corresponding pixels in the tile Iₜ (x,y). If the mean illumination change c is less than the compensation threshold β 514, the pixel differences Δ_{t,2}(x,y) are set 518 such that the results of the uncompensated background subtraction Δ_{t,1}(x,y) 500 will be selected as the minimum 522.

The minimum differences Δₜ(x,y) between the uncompensated background subtraction Δ_{t,1}(x,y) and the gain compensated background subtraction Δ_{t,2}(x,y) are determined 522 and a portion of the foreground mask Hₜ(x,y) corresponding to the tile Iₜ(x,y) is generated by binarizing the minimum differences Δₜ(x,y) based on a threshold Tₜ(x,y) 526. The threshold Tₜ(x,y) is the pixel-wise standard deviation of the variance 520. If a minimum difference in Δₜ(x,y) is less than the threshold Tₜ(x,y), the corresponding location in the foreground image is set to indicate a background pixel; otherwise, the corresponding location is set to indicate a foreground pixel.

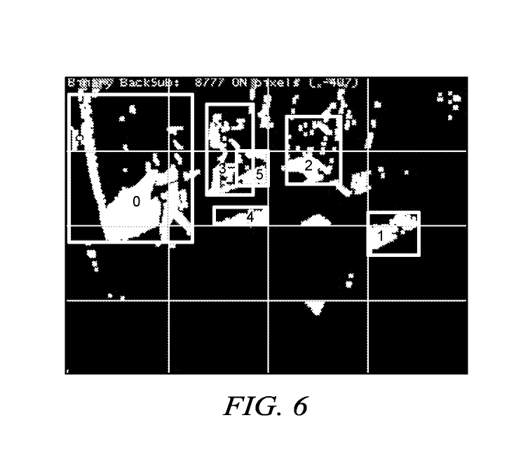

FIG. 6 shows the result of applying an embodiment of the method of FIG. 5 to the image of FIG. 2B with the background model of FIG. 2A. Note that while there is still errors in the segmentation, pixel locations associated with moving objects are much more distinguishable as compared to the result of applying uncompensated background subtraction as shown in FIG. 2C.

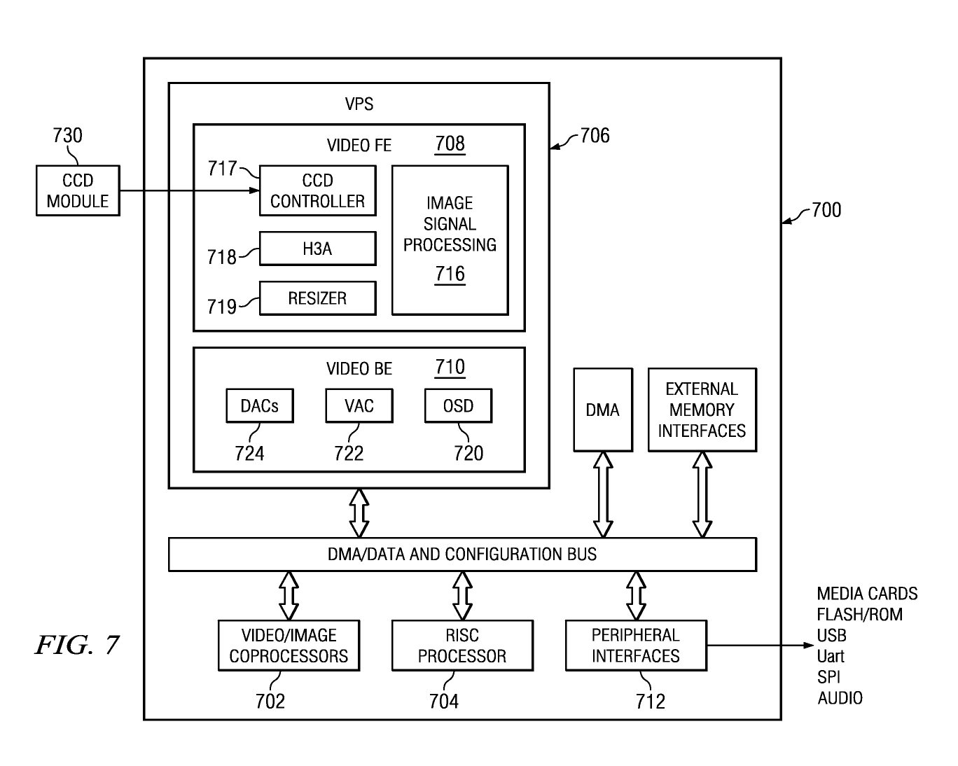

FIG. 7 shows a digital system 700 suitable for use as an embedded system, e.g., in a digital camera. The digital system 700 may be configured to perform video content analysis such as that described above in reference to FIG. 4. The digital system 700 includes, among other components, one or more video/image coprocessors 702, a RISC processor 704, and a video processing system (VPS) 706. The digital system 700 also includes peripheral interfaces 712 for various peripherals that may include a multi-media card, an audio serial port, a Universal Serial Bus (USB) controller, a serial port interface, etc.

The RISC processor 704 may be any suitably configured RISC processor. The video/image coprocessors 702 may be, for example, a digital signal processor (DSP) or other processor designed to accelerate image and/or video processing. One or more of the video/image coprocessors 702 may be configured to perform computational operations required for video encoding of captured images. The video encoding standards supported may include, for example, one or more of the JPEG standards, the MPEG standards, and the H.26x standards. The computational operations of the video content analysis including the background subtraction with dynamic illumination compensation may be performed by the RISC processor 704 and/ or the video/image coprocessors 702. That is, one or more of the processors may execute software instructions to perform the video content analysis and the method of FIG. 5.

The VPS 706 includes a configurable video processing front-end (Video FE) 708 input interface used for video capture from a CCD imaging sensor module 730 and a configurable video processing back-end (Video BE) 710 output interface used for display devices such as digital LCD panels.

The Video FE 708 includes functionality to perform image enhancement techniques on raw image data from the CCD imaging sensor module 730. The image enhancement techniques may include, for example, black clamping, fault pixel correction, color filter array (CFA) interpolation, gamma correction, white balancing, color space conversion, edge enhancement, detection of the quality of the lens focus for auto focusing, and detection of average scene brightness for auto exposure adjustment.

The Video FE 708 includes an image signal processing module 716, an H3A statistic generator 718, a resizer 719, and a CCD controller 717. The image signal processing module 716 includes functionality to perform the image enhancement techniques. The H3A module 718 includes functionality to support control loops for auto focus, auto white balance, and auto exposure by collecting metrics on the raw image data.

The Video BE 710 includes an on-screen display engine (OSD) 720, a video analog encoder (VAC) 722, and one or more digital to analog converters (DACs) 724. The OSD engine 720 includes functionality to manage display data in various formats for several different types of hardware display windows and it also handles gathering and blending of video data and display/bitmap data into a single display window before providing the data to the VAC 722 in YCbCr format. The VAC 722 includes functionality to take the display frame from the OSD engine 720 and format it into the desired output format and output signals required to interface to display devices. The VAC 722 may interface to composite NTSC/PAL video devices, S-Video devices, digital LCD devices, high-definition video encoders, DVI/HDMI devices, etc.

### Other Embodiments

While the invention has been described with respect to a limited number of embodiments, those skilled in the art, having benefit of this disclosure, will appreciate that other embodiments can be devised which do not depart from the scope of the invention as disclosed herein. For example, the meaning of the binary values 0 and 1 in one or more of the various binary masks described herein may be reversed.

Those skilled in the art can also appreciate that the method also applies generally to any background model-based approach. That is, the method is not unique to any particular background model representation. For example, the approach performs equally well when each pixel in the model is defined by uniformly weighted running average and running variance. The method also works with various sensor types, even those collecting measurements outside of the visible spectrum. For example, sensors sensitive to thermal and infrared spectra also experience momentarily changes in the model representation due to sensor noise and environmental flare ups. The method described herein can also compensate for such conditions, providing improved segmentation of foreground pixels. The method also works for background models described by a stereo disparity or depth map.

Embodiments of the background subtraction method described herein may be implemented in hardware, software, firmware, or any combination thereof. If implemented in software, the software may be executed in one or more processors, such as a microprocessor, application specific integrated circuit (ASIC), field programmable gate array (FPGA), or digital signal processor (DSP). Further, the software may be initially stored in a computer-readable medium such as compact disc (CD), a diskette, a tape, a file, memory, or any other computer readable storage device and loaded and executed in the processor. In some cases, the software may also be sold in a computer program product, which includes the computer-readable medium and packaging materials for the computer-readable medium. In some cases, the software instructions may be distributed via removable computer readable media (e.g., floppy disk, optical disk, flash memory, USB key), via a transmission path from computer readable media on another digital system, etc.

Although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein.

It is therefore contemplated that the appended claims will cover any such modifications of the embodiments as fall within the true scope of the invention.

What is claimed is:

1. A method of processing a video sequence in a computer vision system, the method comprising:
receiving a frame of the video sequence;
computing a gain compensation factor for a tile in the frame as an average of differences between background pixels in the tile and corresponding pixels in a background model;
computing a first difference between a pixel in the tile and a sum of a corresponding pixel in the background model and the gain compensation factor; and
setting a location in a foreground mask corresponding to the pixel based on the first difference.

2. The method of claim 1, further comprising:
computing a second difference between the pixel in the tile and the corresponding pixel in the background model, and
wherein setting a location in a foreground mask further comprises setting the location to indicate a foreground pixel when a minimum of the first difference and the second difference exceeds a threshold.

3. The method of claim 1, further comprising:
updating a motion history image based on pixel differences between the frame and a previous frame, wherein a value of a location in the motion history image is representative of change in a value of a corresponding pixel location over a plurality of frames, and
wherein computing a gain compensation factor further comprises using the motion history image to identify the background pixels in the tile.

4. The method of claim 4, wherein using the motion history image comprises:
binarizing the motion history image, wherein a location in the binary motion history image is set to indicate motion in a corresponding pixel if a pixel value has changed over the number of frames and is otherwise set to indicate no motion in the corresponding pixel, and
wherein a pixel in the tile is identified as a background pixel if a corresponding location in the binary motion history image indicates no motion.

5. An apparatus comprising:
means for receiving a frame of a video sequence;
means for computing a gain compensation factor for a tile in the frame as an average of differences between background pixels in the tile and corresponding pixels in a background model;
means for computing a first difference between a pixel in the tile and a sum of a corresponding pixel in the background model and the gain compensation factor; and
means for setting a location in a foreground mask corresponding to the pixel based on the first difference.

6. The apparatus of claim 5, further comprising:
means for computing a second difference between the pixel in the tile and the corresponding pixel in the background model, and
wherein the means for setting a location in a foreground mask further comprises means for setting the location to indicate a foreground pixel when a minimum of the first difference and the second difference exceeds a threshold.

7. The apparatus of claim 5, further comprising:
means for updating a motion history image based on pixel differences between the frame and a previous frame, wherein a value of a location in the motion history image is representative of change in a value of a corresponding pixel location over a plurality of frames, and
wherein the means for computing a gain compensation factor further comprises means for using the motion history image to identify the background pixels in the tile.

8. The apparatus of claim 7, wherein the means for using the motion history image comprises:
means for binarizing the motion history image, wherein a location in the binary motion history image is set to indicate motion in a corresponding pixel if a pixel value has changed over the number of frames and is otherwise set to indicate no motion in the corresponding pixel, and
wherein a pixel in the tile is identified as a background pixel if a corresponding location in the binary motion history image indicates no motion.

9. A computer readable medium storing software instructions executable by a processor in a computer vision system to perform a method of processing a video sequence, the method comprising:
receiving a frame of the video sequence;
computing a gain compensation factor for a tile in the frame as an average of differences between background pixels in the tile and corresponding pixels in a background model;
computing a first difference between a pixel in the tile and a sum of a corresponding pixel in the background model and the gain compensation factor; and
setting a location in a foreground mask corresponding to the pixel based on the first difference.

10. The computer readable medium of claim 9, wherein the method further comprises:
computing a second difference between the pixel in the tile and the corresponding pixel in the background model, and
wherein setting a location in a foreground mask further comprises setting the location to indicate a foreground pixel when a minimum of the first difference and the second difference exceeds a threshold.

11. The computer readable medium of claim 9, wherein the method further comprises:
updating a motion history image based on pixel differences between the frame and a previous frame, wherein a value of a location in the motion history image is representative of change in a value of a corresponding pixel location over a plurality of frames, and
wherein computing a gain compensation factor further comprises using the motion history image to identify the background pixels in the tile.

12. The computer readable medium of claim 11, wherein using the motion history image comprises:
binarizing the motion history image, wherein a location in the binary motion history image is set to indicate motion in a corresponding pixel if a pixel value has changed over the number of frames and is otherwise set to indicate no motion in the corresponding pixel, and
wherein a pixel in the tile is identified as a background pixel if a corresponding location in the binary motion history image indicates no motion.
